(19) United States
(12) Patent Application Publication
(10) Pub. No.: US 2025/0218330 A1
(43) Pub. Date: Jul. 3, 2025

(54) RESAMPLER FOR ELECTRONIC DISPLAY HAVING MULTIPLE PIXEL LAYOUTS

(71) Applicant: Apple Inc., Cupertino, CA (US)

(72) Inventors: Hyun H. Boo, Santa Clara, CA (US); Mario Miscuglio, Sunnyvale, CA (US); Jenny Hu, Santa Clara, CA (US); Ximeng Guan, San Jose, CA (US); Yi Qiao, San Jose, CA (US); Mahesh B. Chappalli, San Jose, CA (US); Zhizhen Ma, Santa Clara, CA (US); Alexey Kornienko, Watford (GB); Tao Jia, Ningbo (CN)

(21) Appl. No.: 18/951,480

(22) Filed: Nov. 18, 2024

Related U.S. Application Data
(60) Provisional application No. 63/617,362, filed on Jan. 3, 2024.

(51) Int. Cl. G09G 3/20

(52) U.S. Cl. CPC G09G 3/2074; G09G 2360/14

(57) ABSTRACT

An electronic device may include a display panel implementing a first region having a first pixel layout and a second region having a second pixel layout, a sensor disposed behind the first region, and image processing circuitry communicatively coupled to the display panel. The image processing circuitry may process image data associated with the first region of the display panel using a first pixel layout resampler and process image data associated with the second region of the display panel using a second pixel layout resampler.

### CROSS-REFERENCE TO RELATED APPLICATIONS

This application claims priority to U.S. Provisional Application No. 63/617,362, entitled “Resampler for Electronic Display Having Multiple Pixel Layouts,” filed Jan. 3, 2024, which is incorporated by reference herein in its entirety.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to electronic displays, which may be used to present visual representations of information as one or more images. To display one or more images, a display panel of an electronic display generally includes display pixels and driver circuitry coupled to the display pixels. In addition to the display panel, the electronic device often includes one or more sensors, such as optical sensors. For example, the electronic device may include an ambient light sensor that is implemented and/or operated to sense (e.g., measure) environmental lighting conditions. The sensors are often implemented (e.g., disposed) along an external surface of an electronic device. In fact, in some instances, the sensor and the display panel may be implemented along the same external surface of an electronic device, which may cause perceivable image artifacts.

In some instances, the display panel may also include opaque (e.g., non-light transmissive) material, for example, which is used to implement switching devices (e.g., transistors) in it display pixels. In other words, the opaque material implemented in the display panel may block light that passes through the external surface of the electronic device from reaching the sensor disposed behind the display panel. As such, to facilitate improving the ability of the sensor implemented behind the display panel to accurately sense light that passes through the external surface of the electronic device, at least a portion of the display panel may be implemented with fewer display pixels and, thus, a lower pixel resolution (e.g., display pixels per square inch). That is, a pixel layout implemented in the portion of the display panel may include the lower pixel resolution, which may result in perceived quality of an image being displayed with pixel resolution.

The same pixel resolution may be implemented using multiple different pixel layouts, which each indicates location and/or color component of display pixels on a display panel. For example, a pixel layout of a lower resolution region may be determined by removing one or more display pixels and/or increasing a spacing between rows and/or columns of the display pixels from a pixel layout of a corresponding high resolution region. In another example, the pixel layout of the lower resolution region may be determined by adapting the pixel layout of the corresponding high resolution region to achieve a target pixel resolution of the lower resolution region.

A perceived luminance of an area (e.g., portion) of a display panel may depend at least in part on pixel resolution implemented therein. For example, when each display pixel emits the same amount of light, perceived luminance of an area in a lower resolution region of the display panel may appear darker than perceived luminance of a same-sized area in a higher resolution region. To facilitate compensating for variations in perceived luminance resulting from differing pixel resolutions, the electronic device may include image processing circuitry implemented and/or operated to process image data before the image data is supplied to a display panel to display a corresponding image. To facilitate determining display image data that compensates for pixel resolution, the image processing circuitry may include a resampler block (e.g., resolution compensation block, circuitry group) implemented and/or operated to determine one or more resolution compensation factors to be applied to input image data, such as source image data and/or image data output from upstream image processing circuitry, based at least in part on pixel resolution implemented in an area of the display panel that includes (e.g., surrounds) a corresponding display pixel. For example, the resolution compensation factors may include one or more offset values, which may bias (e.g., offset) the input image data, one or more gain values, which may scale the image data, and/or one or more filters which may remove high frequency content. By way of example, the resampler may filter the input image data to remove high frequency content from the input image data corresponding to the low resolution area, and also, apply one or more gain values to the corresponding input image data.

For example, the input image data may correspond with a pixel location (e.g., position) in the low resolution region at which a display pixel is not actually implemented. As such, a gain value of zero is being applied to the input image data corresponding with a removed display pixel, for example, after sub-sampling to account for pixel layout. To facilitate reducing perceivability of a transition between a low resolution region and a high resolution region, a resolution compensation factor to be applied to middle resolution region and/or a boundary between the high resolution region and the low resolution region, which may be between a zero gain value and a unity gain value. Moving from the low resolution region towards the high resolution region, the gain resolution compensation factors to be applied to image data corresponding with every other line of display pixels in the middle resolution region may gradually increase. For example, the resolution compensation factors may gradually decrease over the course of a first (e.g., even numbered) set of lines and gradually increase over the course of a second (e.g., odd numbered) set of lines.

The techniques described in the present disclosure may facilitate reducing the perceivability of changes between different pixel resolutions implemented on a display panel of an electronic display to facilitate improving perceived quality of an image being displayed on the display panel. By implementing multiple different pixel resolutions on a display panel, the techniques described in the present disclosure may facilitate balancing (e.g., optimizing and/or maximizing) perceived image quality provided by the display panel and real estate utilization in the display panel, for example, by including a higher (e.g., high) resolution region, a middle resolution region, one or more boundary regions, a lower (e.g., low) resolution region behind which one or more sensors (e.g., optical sensors, light sensors) may be deployed, or any combination thereof. In this way, the display panel may be compensated for perceivable variations resulting from the pixel resolution of a lower resolution region of a display panel in an electronic display, which may facilitate improving perceived quality of an image being displayed on the display panel.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a block diagram of an example portion of the electronic display of FIG. 1 including image processing circuitry and a display panel, in accordance with an embodiment of the present disclosure;

FIG. 8 is a schematic diagram of the electronic device of FIG. 1 with a sensor and two or more regions having different resolutions, in accordance with an embodiment;

FIG. 9A is a schematic diagram of a pixel layout implemented within a region of the electronic device of FIG. 1, in accordance with an embodiment;

FIG. 9B is a schematic diagram of a pixel layout implemented within a region of the electronic device of FIG. 1, in accordance with an embodiment;

FIG. 9C is a schematic diagram of a pixel layout implemented within a region of the electronic device of FIG. 1, in accordance with an embodiment;

FIG. 9D is a schematic diagram of a pixel layout implemented within a region of the electronic device of FIG. 1, in accordance with an embodiment;

FIG. 9E is a schematic diagram of a pixel layout implemented within a region of the electronic device of FIG. 1, in accordance with an embodiment;

FIG. 9F is a schematic diagram of a pixel layout implemented within a region of the electronic device of FIG. 1, in accordance with an embodiment;

FIG. 10 is a schematic diagram of different pixel layouts implemented in different regions of the electronic device of FIG. 1, in accordance with an embodiment;

FIG. 11 an example schematic diagram of the electronic device of FIG. 1 with three regions implementing a respective pixel layout, in accordance with an embodiment;

FIG. 12 is an example schematic diagram of the electronic device of FIG. 1 with two regions having different resolutions and displaying the display image data to form a frame of image content, in accordance with an embodiment;

FIG. 13 is an example schematic diagram of the electronic device of FIG. 1 with two regions having different resolutions and displaying the display image data to form a frame of image content, in accordance with an embodiment;

FIG. 14 is an example schematic diagram of the electronic device of FIG. 1 with three regions having different resolutions and displaying the display image data to form a frame of image content, in accordance with an embodiment;

FIG. 15 is an example schematic diagram of the electronic device of FIG. 1 with three regions having different resolutions and displaying the display image data to form a frame of image content, in accordance with an embodiment;

FIG. 16 is an example schematic diagram of the electronic device of FIG. 1 with three regions having different resolutions and displaying the display image data to form a frame of image content, in accordance with an embodiment;

FIG. 17 is a graph illustrating target luminance levels for display pixels positioned in different regions of the electronic device of FIG. 1, in accordance with an embodiment;

FIG. 18 is a flowchart of an example method for receiving and processing the input image data for the display panel, in accordance with an embodiment; and

FIG. 19 is a flowchart of an example method for receiving and processing the input image data for the display panel, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

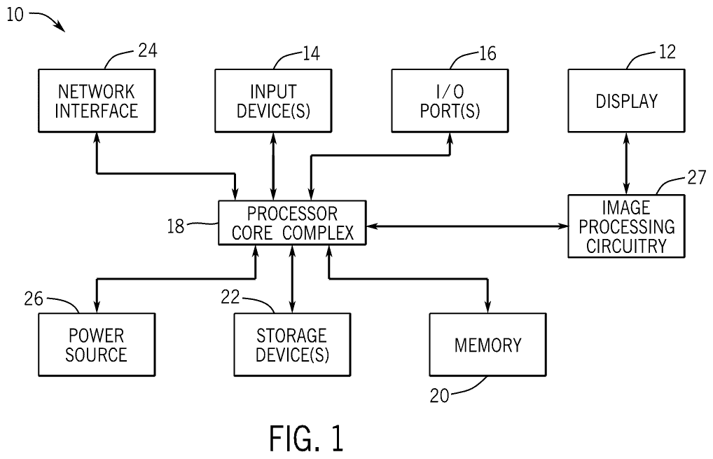

An example of an electronic device 10 having an electronic display 12 is shown in FIG. 1. As will be described in more detail below, the electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a vehicle dashboard, and/or the like. Thus, it should be noted that FIG. 1 is merely one example of a particular implementation and is intended to illustrate the types of components that may be present in an electronic device 10.

In addition to the electronic display 12, the electronic device 10 includes one or more input devices 14, one or more input/output (I/O) ports 16, a processor core complex 18 having one or more processors or processor cores, main memory 20, one or more storage devices 22, a network interface 24, a power supply 26, and image processing circuitry 27. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the main memory 20 and a storage device 22 may be included in a single component. Additionally or alternatively, the image processing circuitry 27 may be included in the processor core complex 18 or the electronic display 12.

As depicted, the processor core complex 18 is operably coupled with main memory 20 and the storage device 22. As such, in some embodiments, the processor core complex 18 may execute instructions stored in main memory 20 and/or a storage device 22 to perform operations, such as generating image data. Additionally or alternatively, the processor core complex 18 may operate based on circuit connections formed therein. As such, in some embodiments, the processor core complex 18 may include one or more general purpose microprocessors, one or more application specific processors (ASICs), one or more field programmable logic arrays (FPGAs), or any combination thereof.

In addition to instructions, in some embodiments, the main memory 20 and/or the storage device 22 may store data, such as image data. Thus, in some embodiments, the main memory 20 and/or the storage device 22 may include one or more tangible, non-transitory, computer-readable media that store instructions executable by processing circuitry, such as the processor core complex 18 and/or the image processing circuitry 27, and/or data to be processed by the processing circuitry. For example, the main memory 20 may include random access memory (RAM) and the storage device 22 may include read only memory (ROM), rewritable non-volatile memory, such as flash memory, hard drives, optical discs, and/or the like.

As depicted, the processor core complex 18 is also operably coupled with the network interface 24. In some embodiments, the network interface 24 may enable the electronic device 10 to communicate with a communication network and/or another electronic device 10. For example, the network interface 24 may connect the electronic device 10 to a personal area network (PAN), such as a Bluetooth network, a local area network (LAN), such as an 802.11x Wi-Fi network, and/or a wide area network (WAN), such as a 4G or LTE cellular network. In other words, in some embodiments, the network interface 24 may enable the electronic device 10 to transmit data (e.g., image data) to a communication network and/or receive data from the communication network.

Additionally, as depicted, the processor core complex 18 is operably coupled to the power supply 26. In some embodiments, the power supply 26 may provide electrical power to operate the processor core complex 18 and/or other components in the electronic device 10, for example, via one or more power supply rails. Thus, the power supply 26 may include any suitable source of electrical power, such as a rechargeable lithium polymer (Li-poly) battery and/or an alternating current (AC) power converter.

Furthermore, as depicted, the processor core complex 18 is operably coupled with one or more I/O ports 16. In some embodiments, the I/O ports 16 may enable the electronic device 10 to interface with another electronic device 10. For example, a portable storage device may be connected to an I/O port 16, thereby enabling the electronic device 10 to communicate data, such as image data, with the portable storage device.

As depicted, the processor core complex 18 is also operably coupled with one or more input devices 14. In some embodiments, an input device 14 may enable a user to interact with the electronic device 10. For example, the input devices 14 may include one or more buttons, one or more keyboards, one or more mice, one or more trackpads, and/or the like. Additionally, in some embodiments, the input devices 14 may include touch sensing components implemented in the electronic display 12. In such embodiments, the touch sensing components may receive user inputs by detecting occurrence and/or position of an object contacting the display surface of the electronic display 12.

In addition to enabling user inputs, the electronic display 12 may facilitate providing visual representations of information by displaying one or more images (e.g., image frames or pictures). For example, the electronic display 12 may display a graphical user interface (GUI) of an operating system, an application interface, text, a still image, or video content. To facilitate displaying images, as will be described in more detail below, the electronic display 12 may include a display panel with one or more display pixels.

As described above, an electronic display 12 may display an image by controlling luminance of its display pixels based at least in part on image data associated with corresponding image pixels (e.g., points) in the image. In some embodiments, image data may be generated by an image source, such as the processor core complex 18, a graphics processing unit (GPU), and/or an image sensor. Additionally, in some embodiments, image data may be received from another electronic device 10, for example, via the network interface 24 and/or an I/O port 16. In any case, as described above, the electronic device 10 may be any suitable electronic device.

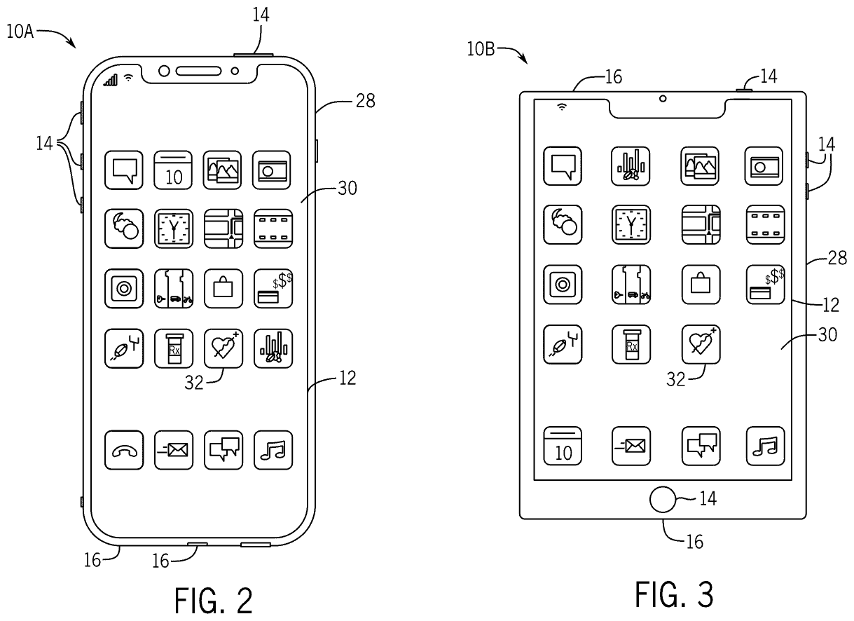

To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For example, the handheld device 10A may be a smart phone, such as any iPhone® model available from Apple Inc.

The handheld device 10A includes an enclosure 28 (e.g., housing). In some embodiments, the enclosure 28 may protect interior components from physical damage and/or shield them from electromagnetic interference. Additionally, as depicted, the enclosure 28 surrounds the electronic display 12. In the depicted embodiment, the electronic display 12 is displaying a graphical user interface (GUI) 30 having an array of icons 32. By way of example, when an icon 32 is selected either by an input device 14 or a touch sensing component of the electronic display 12, an application program may launch.

Furthermore, input devices 14 open through the enclosure 28. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. As depicted, the I/O ports 16 also open through the enclosure 28. In some embodiments, the I/O ports 16 may include, for example, an audio jack to connect to external devices.

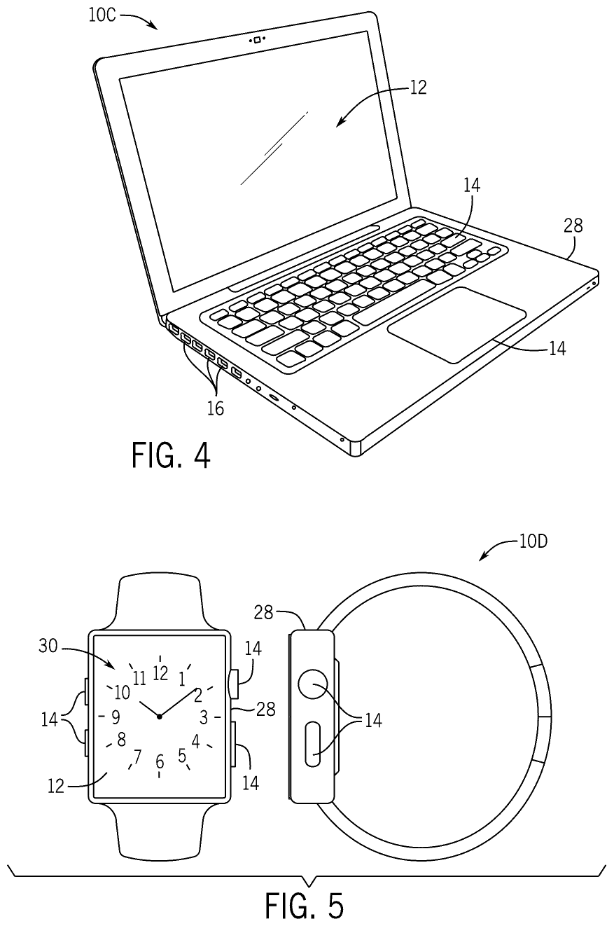

Another example of a suitable electronic device 10, specifically a tablet device 10B, is shown in FIG. 3. For illustrative purposes, the tablet device 10B may be any iPad® model available from Apple Inc. A further example of a suitable electronic device 10, specifically a computer 10C, is shown in FIG. 4. For illustrative purposes, the computer 10C may be any Macbook® or iMac® model available from Apple Inc. Another example of a suitable electronic device 10, specifically a watch 10D, is shown in FIG. 5. For illustrative purposes, the watch 10D may be any Apple Watch® model available from Apple Inc. As depicted, the tablet device 10B, the computer 10C, and the watch 10D each also includes an electronic display 12, input devices 14, I/O ports 16, and an enclosure 28. In any case, as described above, an electronic display 12 may generally display images based at least in part on image data, for example, output from the processor core complex 18 and/or the image processing circuitry 27.

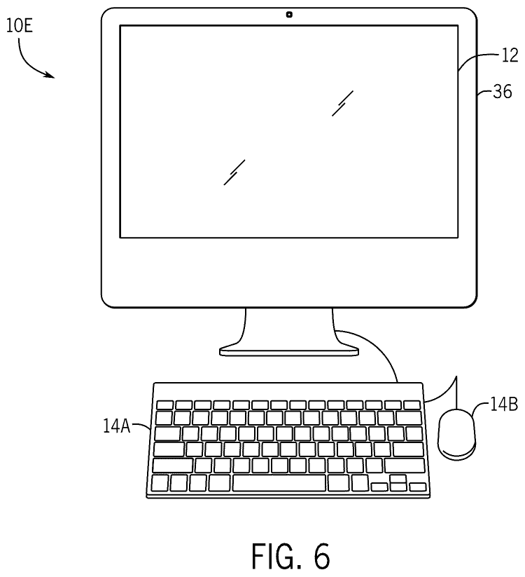

Turning to FIG. 6, a computer 10E may represent another embodiment of the electronic device 10 of FIG. 1. The computer 10E may be any computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 36 may be provided to protect and enclose internal components of the computer 10E, such as the electronic display 12. In certain embodiments, a user of the computer 10E may interact with the computer 10E using various peripheral input structures 14, such as the keyboard 14A or mouse 14B (e.g., input structures 14), which may connect to the computer 10E.

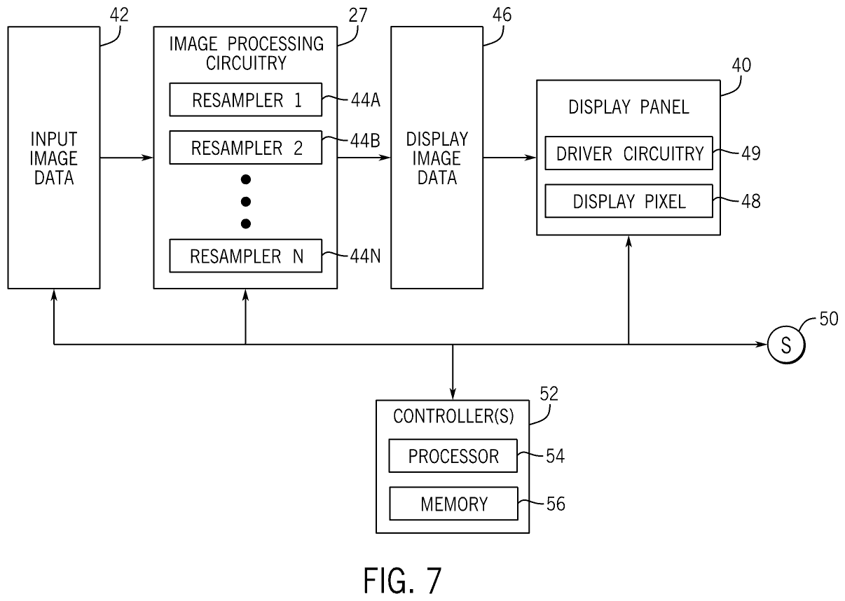

FIG. 7 is a block diagram of a portion of the electronic display 12 including image processing circuitry 27 and a display panel 40. The image processing circuitry 27 may receive input image data 42 from an image source. Generally, the image source may be implemented and/or operated to generate the input image data 42 corresponding with an image (e.g., frame of image content) to be displayed on the display panel 40. Thus, in some embodiments, the image source may be a processor core complex 18, a graphics processing unit (GPU), an image sensor (e.g., camera), and/or the like.

The image processing circuitry 27 may one or more image data processing blocks include a pixel layout resampler (SPLR) block 44 that determines pixel image data (e.g., image data in display format) by filtering (e.g., interpolating or sub-sampling) image pixel image data (e.g., image data in source format). Additionally or alternatively, the resampler 44 may determine a pixel layout associated with a portion of the display panel 40 and determine a resolution compensation factor based on the pixel layout. The resolution compensation factor may include one or more offset values, one or more gain values, and the like that may be applied to the input image data 42. In certain embodiments, the image data processing blocks may additionally or alternatively include an ambient adaptive pixel (AAP) block, a dynamic pixel backlight (DPB) block, a white point correction (WPC) block, a sub-pixel layout compensation (SPLC) block, a burn-in compensation (BIC) block, a panel response correction (PRC) block, a dithering block, a sub-pixel uniformity compensation (SPUC) block, a content frame dependent duration (CDFD) block, an ambient light sensing (ALS) block, or any combination thereof. The image processing circuitry 27 may be included in the processor core complex 18, a display pipeline (e.g., chip or integrated circuit device), a timing controller (TCON) in the electronic display 12, or any combination thereof. Additionally or alternatively, the image processing circuitry 27 may be implemented as a system-on-chip (SoC).

Returning to the resampler 44, the image processing circuitry 27 may include one or more resamples 44 that may adjust the input image data 42 based on a respective pixel layout. The respective resampler 44 may receive the input image data 42 corresponding with a current image pixel, determine a location of the image pixel, adjust the input image data 42 based on a resolution compensation factor associated with the location, and output the display image data 46 corresponding with a current display pixel 48.

The resolution compensation factor may be determined based at least in part on a layout of the pixels in the display panel 40. The resolution compensation factor may include one or more gain values for luminance scaling and/or one or more filtering parameters for filtering the input image data 42. For example, the resampler 44 may use a gain map, which indicates gain values to apply to the input image data 42 corresponding to specific display pixels 48, to determine the resolution compensation factor. The gain values may include a bias (e.g., offset) value, a scaling value, and the like. The resampler 44 may receive pixel layout data from an image data buffer that stores image data corresponding with the pixel layout of the display panel 40, data of the current pixel data, and/or data corresponding to display pixels neighboring the current display pixel 48. Additionally or alternatively, the resolution compensation factor may include one or more filter parameters. For example, a resampler 44 may determine the location of the image pixel being within an area of low resolution and generate the output display image data 46 by applying one or more filter parameters (e.g., filter) to remove high frequency content from corresponding input image data 42. An additional resampler 44 may determine an additional location of an additional image pixel being within an area of higher resolution and may not apply a filter to the corresponding input image data 42.

Additionally or alternatively, the resampler 44 may include a de-gamma block, an edge detection block, and/or a re-gamma block for adjusting the input image data 42. For example, the input image data 42 may be in a gamma (e.g., non-linear) domain, and to facilitate processing, the de-gamma block may convert the input image data 42 from the gamma domain to a linear domain. The edge detection block may determine edge parameters, such as a likelihood of an edge occurring at an offset sub-pixel of the current display pixel and/or expected direction of the edge. The filter block may convert the input image data 42 from the source (e.g., RBG) format to the display (e.g., GRGB) format based at least in part on the edge parameters and/or the pixel layout. In some embodiments, the co-located filter parameters may include filter coefficients, which control strength of applied filtering. Additionally, in some embodiments, the co-located filter parameters may include filter type that, for example, indicates whether to apply a non-separable N×N filter or a separable M×1 horizontal filter and a 1×M vertical filter. Since the filtering and/or adjustments may be done in the linear domain, the re-gamma block may convert the adjusted image data back to the gamma domain.

After adjusting the input image data 42, the image processing circuitry 27 may output the display image data 46 to the display panel 40. The display panel 40 may include one or more display pixels 48 and driver circuitry 49. In some embodiments, each display pixel 48 may emit light of a specific color component, such as a red color component, a blue color component, or a green color component. In other words, as used herein, a “display pixel” may refer to a color component sub-pixel, such as a red sub-pixel that emits red light, a blue sub-pixel that emits blue light, a green sub-pixel that emits green light, or a white sub-pixel that emits white light. The display image data 46 may correspond with a respective display pixel 48 on the display panel 40 may be indicative of its target luminance, for example, by indicating a target grayscale value (e.g., level) that is scaled (e.g., mapped) to a panel brightness setting. The driver circuitry 49 may receive the display image data 46 and drive the display pixels 48 to emit light based on the display image data 46.

The electronic device 10 may also include one or more sensors 50 and a controller (e.g., control circuitry and/or control logic) 52. The one or more sensors 50 may include a temperature sensor, a movement (e.g., accelerometer and/or gyroscope) sensor, and/or an optical (e.g., light) sensor. The controller 52 may receive sensor data, such as image data, output from the sensor 50. Additionally, in some embodiments, the controller 52 may generally control operation of image source, the image processing circuitry 27, the one or more sensors 50, the display panel 40, or any combination thereof. Although depicted as a single controller 52, in other embodiments, one or more separate controllers 52 may be used to control operation of the image source, the image processing circuitry 27, the display panel 40, or any combination thereof.

To facilitate controlling operation, as in the depicted example, the controller 52 may include a controller processor 54 and controller memory 56. In some embodiments, the controller processor 54 may be included in the processor core complex 18 and/or separate processing circuitry and the controller memory 56 may be included in main memory 20, a storage device 22, and/or a separate, tangible, non-transitory computer-readable medium. Additionally, in some embodiments, the controller processor 54 may execute instructions and/or process data stored in the controller memory 56 to control operation of the image source 38, the image processing circuitry 27, the display panel 40, and/or the one or more sensors 50. In other embodiments, the controller processor 54 may be hardwired with instructions that, when executed, control operation of the image source, the image processing circuitry 27, the display panel 40, and/or the one or more sensors 50.

In certain instances, real estate (e.g., space) in an electronic device 10—particularly along an external surface—is often limited, for example, to facilitate reducing physical size (e.g., physical footprint) of the electronic device 10 in an effort to improve its portability. Thus, to facilitate optimizing (e.g., maximizing) available real estate, in some embodiments, the electronic device 10 may include the display panel 40 and one or more sensors 50 may be implemented (e.g., disposed) along overlapping portions of an external surface. To help illustrate, an example of a portion of an electronic device 10, which includes the display panel 40 and the sensor 50, which may be an optical sensor.

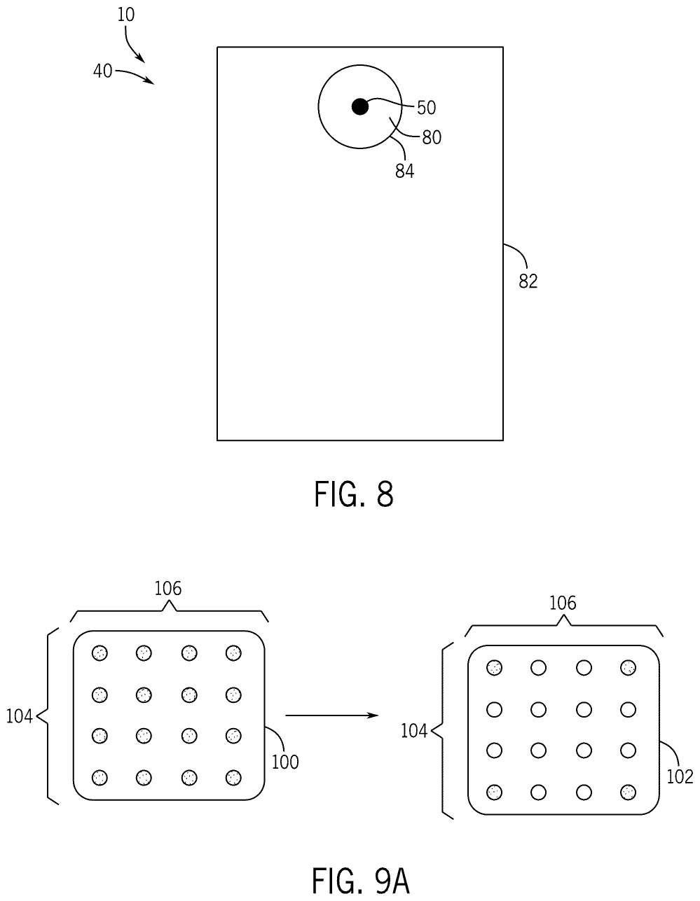

FIG. 8 is a schematic diagram of the electronic device 10 with a sensor 50 and two regions (e.g., resolution regions) 80 and 82 having different pixel resolutions. However, it should be appreciated that the depicted example is merely intended to illustrative and not limiting. For example, in other embodiments, the electronic device 10 may include two or more sensors 50 and/or three or more regions having different resolutions. In another example, the display panel 40 may include three or more different resolution regions and/or two or more sensors 50. That is, the display panel 40 may include any suitable number of sensors 50 and/or regions.

As illustrated, the electronic device 10 may include the sensor 50. For example, the sensor 50 may include an optical sensor, such as an ambient light sensor, deployed in the electronic device 10 to sense (e.g., measure) environmental lighting conditions. Additionally or alternatively, the sensor 50 may be an image sensor, such as a camera, which is implemented and/or operated to capture an image by generating (e.g., outputting) image data, which provides a digital representation of the image, based at least in part on sensed light. The sensor 50 may be implemented (e.g., disposed) along an external surface of the electronic device 10.

The electronic device 10 may include the display panel 40 may be used display images that provide visual representations of information. The display panel 40 and the sensor 50 may be implemented along the same external surface of the electronic device 10. For example, the display panel 40 and the sensor 50 may both be implemented along a front-facing surface of the electronic device 10, a back-facing surface of the electronic device 10, a top-facing surface of the electronic device 10, a bottom-facing surface of the electronic device 10, a left-facing surface of the electronic device 10, a right-facing surface of the electronic device 10, or any combination thereof.

However, real estate (e.g., space) in an electronic device 10—particularly along an external surface—is often limited, for example, to facilitate reducing physical size (e.g., physical footprint) of the electronic device 10 in an effort to improve its portability. Thus, to facilitate optimizing (e.g., maximizing) available real estate, in some embodiments, the display panel 40 and the sensor 50 may be implemented (e.g., disposed) along overlapping portions of an external surface. For example, the display panel 40 may be implemented along a front-facing surface of the electronic device 10 and the sensor 50 may be implemented behind the display panel 40 and, thus, overlap with the display panel 40 along the front-facing surface of the electronic device 10.

However, at least in some instances, the display panel 40 may also include opaque (e.g., non-light transmissive) material, for example, which is used to implement switching devices (e.g., transistors) in it display pixels 48, storage capacitors in its display pixels 48, data lines coupled to its display pixels 48, and/or scan lines coupled to its display pixels 48. In other words, at least in some instances, opaque material implemented in the display panel 40 may block light from reaching the sensor 50 disposed behind the display panel 40 and, thus, potentially affect (e.g., reduce) the ability of the sensor 50 to accurately sense light that passes through the external surface of the electronic device 10. Additionally or alternatively, the amount of opaque material that blocks light from each an sensor 50 may depend at least in part on the number of display pixels 48 and, thus, pixel resolution implemented in front of (e.g., overlapping with) the sensor 50. However, at least in some instances, perceived quality of an image displayed on a display panel 40 may also vary with pixel resolution, for example, a lower pixel resolution may reduce the ability to depict details of an image compared to a higher pixel resolution.

Thus, to enable the sensor 50 to be disposed behind a display panel 40 while improving the perceived image quality provided by the display panel 40, in some embodiments, the display panel 40 may be implemented with multiple regions that each implement a different pixel resolution. For example, the display panel 40 may include a low (e.g., lower) resolution region 80 implemented with pixel layout having a lower (e.g., downsampled) pixel resolution and a high (e.g., higher) resolution region 82 implemented with a higher (e.g., full) pixel resolution. The low resolution region 80 may implement a pixel layout that may include increased spacing and/or a decreased number of display pixels 48 in comparison to the high resolution region 82. Additionally, in some embodiments, the pixel resolution of the low resolution region 60 may be a fraction of the pixel resolution implemented in the high resolution region 62. For example, in some such embodiments, the low resolution region 60 may be implemented with a pixel resolution that is half the pixel resolution of the high resolution region 62. In other embodiments, the low resolution region 60 may be implemented with a pixel resolution that is a different fraction (e.g., a third or a quarter) of the pixel resolution of the high resolution region 82.

To reduce perceivable changes between different pixel resolutions, the image processing circuitry 27 may adjust (e.g., process, filter) the input image data 42 based on the pixel resolution of the low resolution region 80 and/or the high resolution region 82. For example, a first resampler 44A may adjust the input image data 42 based on the pixel resolution of the low resolution region 80 and a second resampler 44B may adjust the input image data 42 based on the pixel resolution of the high resolution region 82. The first resampler 44A may apply a first resolution compensation factor to a portion of the input image data 42 corresponding to the low resolution region 80 and the second resampler 44B may apply a second resolution compensation factor to a portion of the input image data 42 corresponding to the high resolution region 82. Additionally or alternatively, a third resampler 44C may adjust a portion of the input image data 42 corresponding to a boundary region (e.g., boundary area) 84 between the low resolution region 80 and the high resolution region 82. By applying individual resolution compensation factors for each respective region, the perceivability of changes between the different regions implemented on the display panel may be reduced, which may facilitate improving the perceived quality of image being displayed on the display panel 40.

In some embodiments, multiple different pixel layouts may provide the same pixel resolution. In fact, in some embodiments, the pixel layout of the low resolution region 80 may be determined by adapting the pixel layout of the high resolution region 82 to achieve a target pixel resolution of the low resolution region 80. For example, to implement a target pixel resolution that is half the pixel resolution of the high resolution region 82, the pixel layout of the low resolution region 80 may be determined by removing every other line of display pixels 48 from the pixel layout of the high resolution region 82.

To facilitate improving the ability of the sensor 50 to accurately sense light that passes through the external surface of the electronic device 10, as in the depicted example, the sensor 50 may be implemented (e.g., disposed) behind the low resolution region 80. Due to the lower pixel resolution of the low resolution region 80, implementing the sensor 50 in this manner may facilitate reducing the amount of light that is blocked from reaching the sensor 50 by opaque material implemented in the display panel 40, for example, compared to implementing the sensor 50 behind the high resolution region 82 of the display panel 40. In other words, implementing the sensor 50 behind the low resolution region 80 may facilitate increasing the amount of light that passes through the external surface of the electronic device 10 and actually reaches the sensor 50, which, at least in some instances, may facilitate improving the ability of the sensor 50 to accurately sense light that passes through the external surface of the electronic device 10.

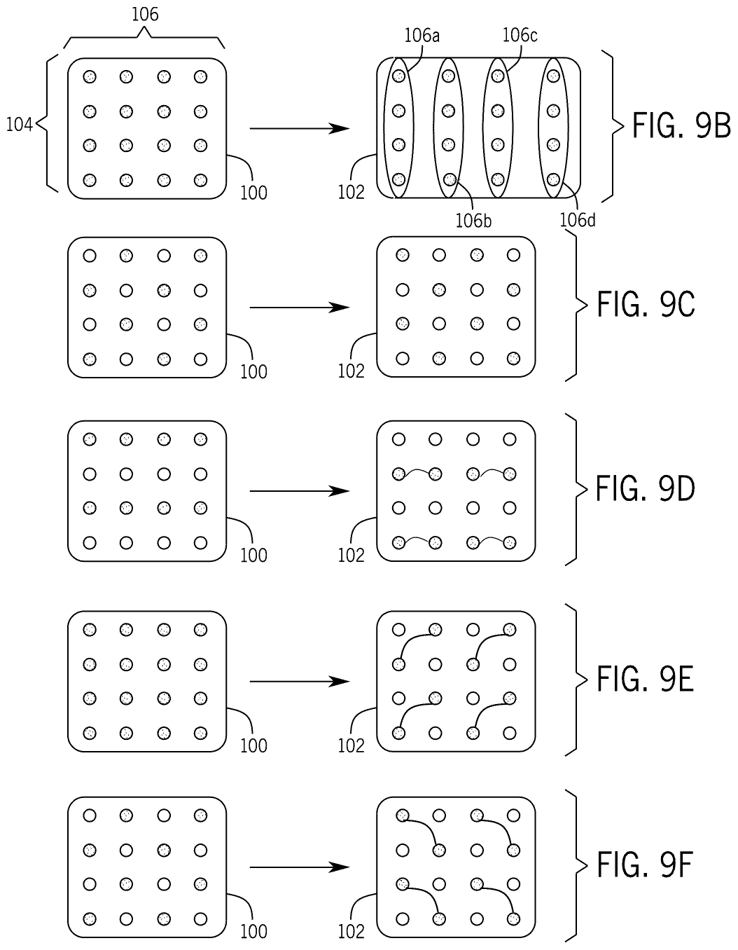

With the foregoing in mind, FIGS. 9A-F illustrated example pixel layouts implemented with the lower resolution region 80 of the electronic device 10. It should be noted that FIGS. 9A-F are merely illustrative examples, and the pixel layout implemented in the low resolution region 80 and/or the high resolution region 82 may include any suitable number of display pixels 48 and/or spacing between the display pixels 48. For example, a pixel layout of a low resolution region 80 may be determined by removing one or more display pixels 48, turning off one or more display pixels 48, and/or increasing a spacing between pixel rows and/or pixel columns of the display pixels 48 from a pixel layout of a corresponding high resolution region 82. Accordingly, at least in some embodiments, the input image data 42 may correspond with a pixel location (e.g., position) in the low resolution region 80 at which a display pixel 48 is not actually implemented. In other words, effectively, a gain value of zero is being applied to the input image data 42 corresponding with a removed display pixel 48, for example, after sub-sampling to account for pixel layout.

For example, FIG. 9A is a schematic diagram of first pixel layout 100 implementing a high pixel resolution and a second pixel layout 102 implementing a low pixel resolution. For example, the first pixel layout 100 may be implemented in the high resolution region 82 and the second pixel layout may be implemented in the low resolution region 80.

As in the depicted example, the first pixel layout 100 and the second pixel layout 102 may be organized in pixel rows 104 and pixel columns 106. For example, the pixel layouts 100, 102 may include four pixel rows 104 and four pixel columns 106 that may be equally spaced. In the first pixel layout 100, each of the display pixels 48 may be driven to emit light and form a frame of image content. In the second pixel layout 102, a portion of the display pixels 48 may be turned off and/or not driven to emit light. For example, two display pixels 48 in a first pixel row 104 and two display pixels 48 in a last pixel row 104 may be driven to emit light. The display pixels 48 located in a second pixel row 104 and a third pixel row 104 may be turned off and/or not driven to emit light. In certain instances, the portion of the display pixels 48 may be removed and/or may not be implemented in the second pixel layout 102. As such, the second pixel layout 102 may implement a lower pixel resolution in comparison to the first pixel layout 100.

FIG. 9B is a schematic diagram of a first pixel layout 100 implementing a high pixel resolution and a second pixel layout 102 implementing a low pixel resolution. As illustrated, the first pixel layout 100 and the second pixel layout 102 may implement the display pixels 48 in pixel rows 104 and pixel columns 106. In the first pixel layout 100, the pixel rows 104 and the pixel columns 106 may be uniformly spaced. In addition, each of the display pixels 48 may be driven to emit light to form a frame of the image content.

In the second pixel layout 102, the spacing between each pixel column 106 may increase, which may decrease the pixel resolution of the second pixel layout 102. For example, the spacing may linearly increase as the number of pixel columns 106 increase. As illustrated, the spacing between a second pixel column 106b and a third pixel column 106c may be greater than the spacing between the second pixel column 106b and the first pixel column 106a. In another example, the spacing between each pixel column 106 may be linearly decreasing such that the spacing between the first pixel column 106 and the second pixel column 106 may be greater than the spacing between the second pixel column 106 and the third pixel column. By increasing the spacing between each pixel column 106, the second pixel layout 102 may implement a lower pixel resolution in comparison to the first pixel layout 100.

In other instances, the spacing between each pixel column 106 may be exponential, logarithmic, geometric, angular, and the like. Additionally or alternatively, the spacing between each pixel row 104 may increase, which may decrease the pixel resolution of the second pixel layout 102. For example, the spacing between a second pixel row 104 and a third pixel row 104 may be greater than the spacing between the second pixel row 104 and the first pixel row 104. In another example, the spacing between a fifth pixel row 104 and a fourth pixel row 104 may be greater than the spacing between the fourth pixel row 104 and the third pixel row 104, the third pixel row 104 and the second pixel row 104, and/or the second pixel row 104 and the first pixel row 104. Still in another example, the spacing between both the pixel rows 104 and the pixel columns 106 may be adjusted.

FIG. 9C is a schematic diagram of a first pixel layout 100 implementing a high pixel resolution and a second pixel layout 102 implementing a low pixel resolution. The first pixel layout 100 may implement a first pattern. For example, the first pixel layout 100 may include even numbered display pixels 48 in a first pixel row 104 being driven to emit light and odd numbered display pixels 48 in a second pixel row 104 being driven to emit light. That is, every other display pixel 48 may be driven to emit light. The pattern may continue for each subsequent pixel row.

The second pixel layout 102 may implement a second pattern that may be different from the first pattern. For example, the second pixel layout 102 may include odd numbered display pixels 48 in the first pixel row 104 being driven to emit light and even numbered display pixels 48 in the second pixel row 104 being driven to emit light.

In certain instances, the second pixel layout 102 may include a fewer number of display pixels 48 driven to emit light in comparison to the first pixel layout 100. For example, the first pixel row 104 may include a first display pixel 48 being driven to emit light, two subsequent display pixels 48 not being driven to emit light, and a fourth display pixel 48 being driven to emit light. Additionally or alternatively, a second pixel row 104 may include two display pixels 48 not being driven to emit light, a subsequent display pixel 48 being driven to emit light, and an additional display pixel 48 not being driven to emit light. This pattern may continue for subsequent pixel rows 104. In this way, the number of display pixels 48 in the second pixel layout 102 being driven to emit light may be less than the number of display pixels 48 in the first pixel layout 100 being driven to emit light.

In certain instances, the display pixels 48 not being driven to emit light may not be implemented into the display panel 40. By removing a number of display pixels 48, the second pixel layout 102 may include a number of display pixels 48 less than the number of display pixels 48 implemented in the first pixel layout 100. For example, in comparison to the first pixel layout 100, the second pixel layout 102 may implement half as many display pixels 48. In another example, the second pixel layout 102 may implement ⅓ of the number display pixels 48 implemented in the first pixel layout 100, ¼ of the number of display pixels 48 implemented in the first pixel layout 100, ⅕ of the number of display pixels 48 implemented in the first pixel layout 100, and so on.

FIG. 9D is a schematic diagram of a first pixel layout 100 implementing a high pixel resolution and a second pixel layout 102 implementing a low pixel resolution. For example, as illustrated, the first pixel layout 100 may drive every other pixel row 104 to emit light and form the frame of image content. The odd numbered pixel rows 104 may be driven to emit light, while the even numbered pixel rows 104 may not be driven to emit light. In certain instances, the even numbered pixel rows 104 may be driven to emit light, while the odd numbered pixel rows 104 may not be driven to emit light. Additionally or alternatively, the first pixel layout 100 may drive every other pixel column 106 to emit light.

The second pixel layout 102 may include a reduced pixel resolution in comparison to the first pixel layout 100. As illustrated, the second pixel layout 102 may drive the even numbered pixel rows 104 to emit light. In addition, the display pixels 48 in the second pixel layout 102 may be driven to emit light in pairs, such that both display pixels 48 may be driven to emit light at the same target luminance. As illustrated, each pixel row 104 may include four display pixels 48. A first display pixel 48 and a second display pixel 48 may be driven to emit light at the same target luminance at the same time and a third display pixel 48 and a fourth display pixel 48 may be driven to emit light at the same target luminance at the same time. The pattern may continue for subsequent pixel rows 104 that may be implemented by the second pixel layout 102. Due to driving the display pixels 48 in pairs, the second pixel layout 102 may implement a reduced resolution in comparison to the first pixel layout 100.

FIG. 9E is a schematic diagram of a first pixel layout 100 implementing a high pixel resolution and a second pixel layout 102 implementing a low pixel resolution. For example, the first pixel layout 100 may organize the display pixels 48 into pixel rows 104 and pixel columns 106 and drive each display pixel 48 to emit light to display a high resolution image.

The second pixel layout 102 may implement a lower pixel resolution in comparison to the first pixel layout 100 by driving the display pixels 48 in pairs. For example, the second pixel layout 102 may drive every other display pixel 48 to emit light. In addition, the second pixel layout 102 may drive adjacent display pixels 48 with the same target luminance (e.g., same value). As illustrated, the even numbered display pixels 48 in the first pixel row 104 may be driven to emit light and the odd numbered display pixels 48 in the second pixel row 104 may be driven to emit light. The second display pixel 48 in the first pixel row 104 and the first display pixel 48 in the second pixel row 104 may be simultaneously driven to emit light at the same target luminance. In addition, a fourth display pixel 48 in the first pixel row 104 and the third display pixel 48 in the third pixel row 104 may be simultaneously driven to emit light at the same target luminance. The pattern may continue for subsequent pixel rows 104 that may be implemented by the second pixel layout 102. In this way the second pixel layout 102 may implement a lower pixel resolution in comparison to the first pixel layout 100.

FIG. 9F is a schematic diagram of a first pixel layout 100 implementing a high pixel resolution and a second pixel layout 102 implementing a low pixel resolution. The first pixel layout 100 may implement a pattern such that every other display pixel 48 may be driven to emit light. For example, even numbered display pixels 48 may be driven to emit light in the first pixel row 104 and odd numbered display pixels 48 may be driven to emit light in the second pixel row 104.

The second pixel layout 102 may implement a lower pixel resolution and a different pattern in comparison to the first pixel layout 100. For example, the odd numbered display pixels 48 may be driven to emit light in the first pixel row 104 and the even numbered display pixels 48 may be driven to emit light in the second pixel row 104. In addition, the display pixels 48 may be driven to emit light in pairs. For example, a first display pixel 48 in the first pixel row 104 and a second display pixel 48 in the second pixel row 104 may be driven to emit light at the same target luminance. In addition, the third display pixel 48 in the first pixel row 104 and the fourth display pixel 48 in the second pixel row 104 may be driven to emit light at the same target luminance. The pattern may continue for subsequent pixel rows 104 that may be implemented by the second pixel layout 102. In this way, the second pixel layout 102 may implement a lower pixel resolution and a different pattern in comparison to the first pixel layout 100. The lower resolution region 80 may include a second pixel layout 102 with a reduced resolution and different pattern.

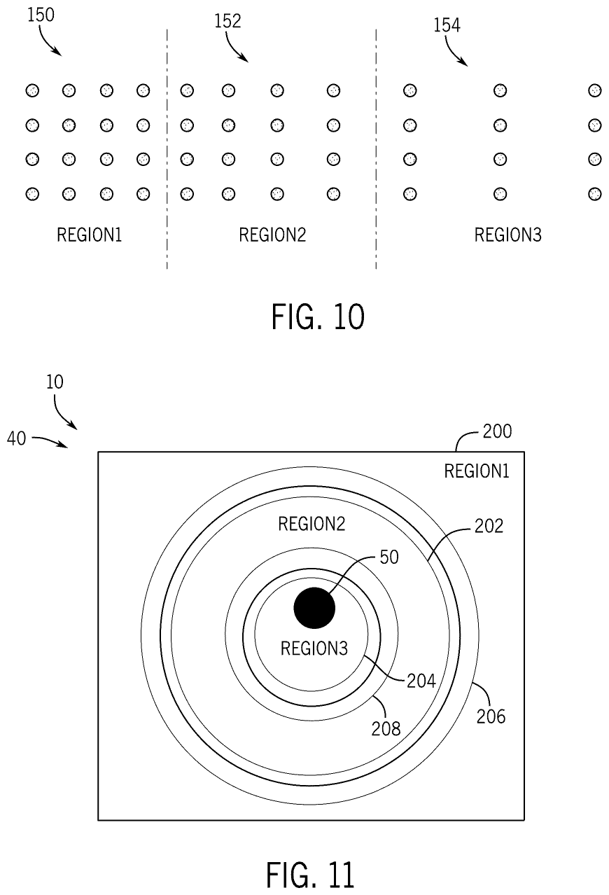

Different pixel layouts may be implemented in respective regions to accommodate one or more sensors placed behind the display panel. For example, FIG. 10 is a schematic diagram of respective pixel layouts implemented within different resolution regions of the electronic device 10. For example, a first pixel layout 150 (e.g., the first pixel layout 100 described with respect to FIG. 9) may include a high resolution pixel layout implemented in a first region of the display panel 40, a second pixel layout 152 (e.g., the second pixel layout 102 described with respect to FIG. 9) may include a middle resolution pixel layout implemented in a second region of the display panel 40, and/or a third pixel layout 154 (e.g., the second pixel layout 102 described with respect to FIG. 9) may include a low resolution pixel layout implemented in a third region of the display panel 40. The pixel resolution of the first pixel layout 150 may be greater than the pixel resolution of the second pixel layout 152, the third pixel layout 154, or both.

For example, the first pixel layout 150 may organize the display pixels 48 into pixel rows and pixel columns with equal spacing. Each of the display pixels 48 may be driven to emit light to display a frame of image content. In contrast, the third pixel layout 154 may include the display pixels 48 in pixel rows and pixel columns with increased spacing between each of the pixel columns. By increasing the spacing between each pixel column, the third pixel layout 154 may implement fewer display pixels 48 in the same amount of area in comparison to the first pixel layout 150. In this way, the pixel resolution of the third pixel layout 154 may be less than the pixel resolution of the first pixel layout 150.

The second pixel layout 152 may implement a pixel layout with a pixel resolution between the first pixel layout 150 and the third pixel layout 154. For example, the second pixel layout 152 may be a transition pixel layout to reduce image artifacts that may be perceivable due to the transition between the first pixel layout 150 and the third pixel layout 154. For example, the second pixel layout 152 may increase spacing between each pixel column to provide a transition from the first pixel layout 150 and the third pixel layout 154. As such, a perceivable transition between the first pixel layout 150 and the third pixel layout 154 may be reduced or eliminated.

FIG. 11 is an example schematic diagram of the electronic device of 10 having three regions 200, 202, 204 that implement respective pixel layouts and/or pixel resolutions. For example, the electronic device 10 may include a display panel 40 that implements a first region 200 (e.g., the high resolution region 82 described with respect to FIG. 8), a second region 202, and/or a third region 204 (e.g., the low resolution region 80 described with respect to FIG. 8). The sensor 50 may be disposed within the electronic device 10 behind the display panel 40 in a region corresponding to the third region 204. Although the illustrated electronic device 10 includes three regions with respective pixel resolutions, as discussed herein, the electronic device 10 may include any suitable number of regions that may implement different display pixel layouts.

In certain instances, the first region 200 may include a high resolution pixel layout (e.g., the first pixel layout 150 described with respect to FIG. 10), a second region 202 may include a middle resolution pixel layout (e.g., the second pixel layout 152 described with respect to FIG. 10), and/or a third region 204 may include a low pixel resolution pixel layout (e.g., the third pixel layout 154 described with respect to FIG. 10). As discussed herein, the first region 200 may drive each display pixel 48 within the region to emit light, which may result in a high pixel resolution. In contrast, the third region 204 may implement a lower pixel resolution to facilitate improving operation of the sensor 50. The second region 202 may facilitate a transition between the first region 200 and the third region 204 to reduce perceivable image artifacts caused by the transition.

In addition, the display panel 40 may implement one or more boundary regions 206, 208 between each of the regions 200, 202, 204 to reduce or eliminate perceivable changes between each of the regions 200, 202, 204. For example, a first boundary region 206 may be positioned between the first region 200 and the second region 202, and a second boundary region 208 may be positioned between a second region 202 and a third region 204. The first boundary region 206 may include a pixel resolution in between the pixel resolution of the first region 200 and the second region 202. The second boundary region 208 may include a pixel resolution between the pixel resolution of the second region 202 and the third region 204. In this way, the boundary regions 206, 208 may reduce or eliminate perceivability of changes between different pixel resolutions and/or pixel layouts.

Since each region 200, 202, 204 implements a different pixel layout, a respective resampler 44 may adjust the input image data 42 based on the pixel layout. For example, a first resampler 44A may adjust the input image data 42 for the first region 200, a second resampler 44B may adjust the input image data 42 for the second region 202, a third resampler 44C may adjust the input image data 42 for the third region 204, and so on. For example, the resampler 44 may receive an indication of the pixel layout, a gain map with the pixel layout, a filter based on the pixel layout, and the like. The resampler 44 may determine a resolution compensation factor for the respective region based on the pixel layout. For example, the resampler 44 may determine a gain value based on the gain map and apply the gain value to the input image data 42 to generate the display image data 46. In another example, the resampler 44 may apply a filter and/or a mask to the input image data 42 to generate the display image data 46. to a target luminance that may be perceived as uniform across the display panel 40.

The resampler 44 may adjust the input image data 42 based on the determined resolution compensation factor to generate the display image data 46. For example, since the third region 204 implements fewer display pixels 48 in comparison to the first region 200, the third resampler 44C may determine a larger resolution compensation factor in comparison to the first resampler 44A. By applying the resolution compensation factor based on the pixel layout, the frame of image content displayed on the display panel 40 may be perceived with reduced image artifacts and/or without perceivable image artifacts, thereby improving the perceived quality of the image being displayed on the display panel 40. In addition, the sensor 50 may accurately sense light that passes through the display panel 40 due to the reduced pixel resolution of the third region 204.

In addition, the electronic device 10 may include respective resamplers 44 that receive input image data 42 and adjusts the input image data 42 based on the pixel layout of the boundary regions 206, 208. That is, a fourth resampler 44D may adjust the input image data 42 based on a resolution compensation factor determined based on the pixel layout of the first boundary region 206, and a fifth resampler 44E may adjust the input image data 42 based on a resolution compensation factor determined based on the pixel layout of the second boundary region 208. Since each resolution compensation factor may be determined based on the pixel layout, the resamplers 44 may facilitate reducing the perceivability of changes between multiple different pixel resolutions and/or pixel layouts implemented on the display panel 40, thereby improving the perceived quality of image content being displayed.

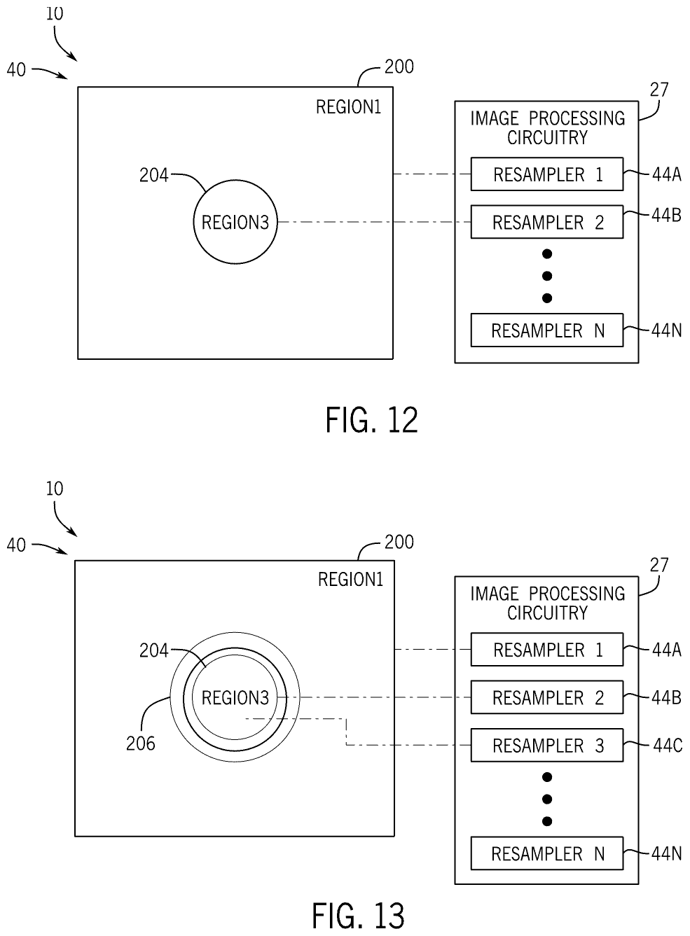

FIG. 12 is an example schematic diagram of the electronic device 10 with two regions having different resolutions. For example, the first region 200 may include a high resolution region and the second region 202 may include a low resolution region or vice versa. In other words, the pixel layout of the first region 200 may be different from the pixel layout of the second region 202.

Each region 200 may be programmed with display image data 46 that may be adjusted with a resolution compensation factor determined based on the pixel layout of the respective region. To this end, the image processing circuitry 27 may include a first resampler 44A that adjusts the input image data 42 for the first region 200 and a second resampler 44B that adjusts the input image data 42 for the second region 202. For example, the respective resamplers 44 may receive input image data 42, receive an indication of the pixel layout of the respective region 200, 202, 204, determine the resolution compensation factor based on the pixel layout, and generate the display image data 46 by applying the resolution compensation factor to the input image data 42. The input image data 42 indicates a target luminance of color components at locations (e.g., image pixels) in the image. The resamplers 44 may adjust the target luminance based on the pixel layout such that the image content being displayed may be perceived without transitions between the regions.

When utilized with the display panel 40, the resampler 44 may determine the pixel layout. For example, the resampler 44 may receive an indication of a pattern being implemented within the respective region. The pattern may include one or more display pixels 48 that may be driven to emit light, such as odd numbered pixels within the pixel row, even numbered pixels within the pixel row, or a combination thereof. The resampler 44 may determine the pixel layout based on the pattern. In another example, the resampler 44 may receive an indication of respective display pixels 48 being driven to emit light and remaining display pixels 48 to determine the pixel layout. Additionally or alternatively, the pixel layout may be pre-determined and stored, for example, by a manufacturer in the controller memory 56. The controller 52 may transmit the pixel layout of the first region 200 to the first resampler 44A, the pixel layout of the second region 202 to the second resampler 44B, and so on. As such, the resamplers 44 may determine the resolution compensation factor and adjust the input image data 42 to generate the display image data 46.

FIG. 13 is an example schematic diagram of the electronic device 10 with two regions 200 and 204 having different resolutions and displaying the display image data 46 to form a frame of image content. The sensor 50 may be implemented behind the display panel 40 in a location corresponding to the third region 204. To improve operation of the sensor 50, the third region 204 may implement a low pixel resolution. To improve image quality, the first region 200 may implement a pixel resolution greater than the pixel resolution implemented in the third region 204. The display panel 40 may also implement a boundary region 206 between the first region 200 and the third region 204. The boundary region 206 may implement a pixel resolution between the first region 200 and the third region 204 to facilitate a boundary between the two regions.

Although the illustrated third region 204 is circular, it may be understood that the regions may be any suitable shape or size. For example, a shape of the third region 204 may be rectangular, oval, hexagonal, square, and the like. Additionally or alternatively, the size of the third region 204 may be increased or decreased based on the size of the sensor 50 to facilitate light transmissions to the sensor 50. Additionally or alternatively, the third region 204 may be implemented in any suitable location of the display panel 40 that corresponds to the location of the sensor 50. For example, the third region 204 may be positioned adjacent to a top edge of the display panel 40, a bottom edge of the display panel 40, a left edge of the display panel 40, a right edge of the display panel 40, a middle portion of the display panel 40, and so on.

Returning to the electronic device 10, the electronic device 10 may include the image processing circuitry 27 with one or more resamplers 44 that receives and adjusts the input image data 42 based on the pixel resolution and/or pixel layout of the respective region 200, 204 and/or boundary region 206. For example, the first resampler 44A may receive a portion of the input image data 42 corresponding to the first region 200, determine a pixel layout corresponding to the first region 200, and apply a first resolution compensation factor to the input image data 42 based on the pixel layout of the first region 200. Similarly, the second resampler 44B may receive a portion of the input image data 42 corresponding to the third region 204, determine a pixel layout corresponding to the third region 204, and apply a second resolution compensation factor to the input image data 42 based on the pixel layout of the third region 204. In certain instances, a third resampler 44C may receive a portion of the input image data 42 corresponding to the boundary region 206, determine a pixel layout of the boundary region, and apply a third resolution compensation factor to the input image data 42 based on the pixel layout of the boundary region 206. Additionally or alternatively, the third resampler 44C may determine the pixel layout of the adjacent regions and determine the third resolution compensation factor based on the pixel layout of the adjacent regions. Additionally or alternatively, the first resampler 44A and/or the second resampler 44B may receive the input image data 42 and determine a portion of the input image data 42 corresponding to the first region 200 and the third region 204, respectively.

In certain instances, the resolution compensation factor applied to the third region 204 may be greater than the resolution compensation factor applied to the first region 200 due to the lower pixel resolution of the third region 204. As discussed herein, the sensor 50 may be positioned behind the display panel 40 in a location corresponding to the third region 204. To improve light transmissions to the sensor 50, display pixels 48 may not be implemented into the third region 204 and/or display pixels 48 within the third region 204 may be turned off, thereby decreasing the pixel resolution of the third region 204. To compensate for the lower pixel resolution of the third region 204, the resolution compensation factor applied to the input image data 42 corresponding to the third region 204 may be greater than the resolution compensation factor applied to input image data 42 corresponding to the first region 200. For example, the target luminance levels for the third region 204 may be greater than the target luminance levels of the first region 200 to compensate for the decreased number of display pixels 48.

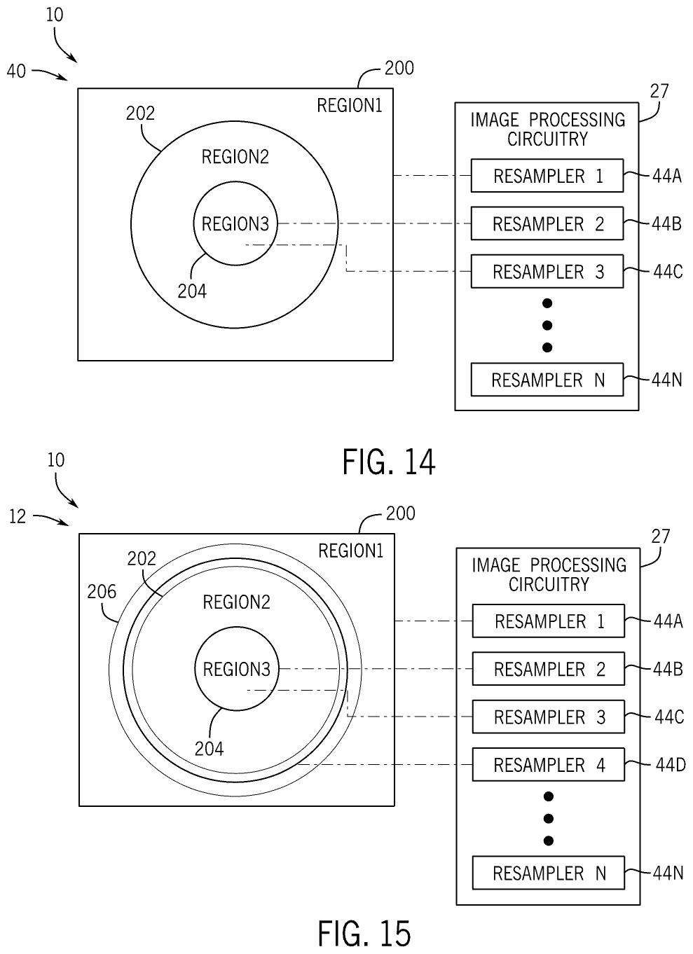

FIG. 14 is an example schematic diagram of the electronic device 10 with three regions 200, 202, and 204 having different resolutions and displaying the display image data 46 to form a frame of image content. For example, the first region 200 may implement a high pixel resolution, the second region 202 may implement a middle pixel resolution, and the third region 204 may implement a low pixel resolution. The pixel layout of the first region 200 may include a total number of display pixels 48 implemented into the display panel 40 to implement the high pixel resolution. The pixel layout of the second region 202 may include a number of display pixels 48 less than the number of display pixels 48 implemented in the first region 200. The pixel layout of the third region 204 may include a number of display pixels less than the second region 202. As such, the third region 204 may improve light transmissions through the display panel 40 to the sensor 50.

The image processing circuitry 27 may include one or more resamplers 44 that receive and process the input image data 42 for a respective region 200, 202, 204, 206. As discussed herein, the first resampler 44A may adjust input image data 42 corresponding to the first region 200, the second resampler 44B may adjust the input image data 42 corresponding to the second region 202, the third resampler 44C may adjust input image data 42 corresponding to the third region 204, and the fourth resampler 44D may adjust input image data 42 corresponding to the boundary region 206. For example, the first resampler 44A may apply a first resolution compensation factor to the portion of the image data corresponding to the first region 200, the second resampler 44B may apply a second resolution compensation factor to the portion of the image data corresponding to the second region 202, and/or the third resampler 44C may apply a third resolution compensation factor to the portion of the image data corresponding to the third region 204. In certain instances, the first region 200 may include a total number of display pixels 48 and the first resampler 44A may not apply the resolution compensation factor to the input image data 42 corresponding to the first region 200 and the remaining resamplers 44 may apply the resolution compensation factor to increase a target luminance of the other regions 202, 204. In other instances, the first resampler 44A may apply a resolution compensation factor less than one to decrease the target luminance of the input image data 42 corresponding to the first region 200.

FIG. 15 is an example schematic diagram of the electronic device 10 with three regions 200, 202, and 204 having different resolutions and displaying the display image data 46 to form a frame of image content. As discussed herein, the first region 200 may include high pixel resolution, the second region 202 may include a middle pixel resolution, and the third region 204 may include a low pixel resolution. Between the first region 200 and the second region 202, the display panel 40 may include a first boundary region 206. The first boundary region 206 may include a resolution between the high pixel resolution and the middle pixel resolution. As such, the first boundary region 206 may facilitate reducing the perceivability of changes between the first region 200 and the second region 202, which may facilitate decreasing any perceivable image artifacts that may result from different pixel resolutions.

As discussed herein, the image processing circuitry 27 may include one or more resamplers 44 that receive and process the input image data 42 for a respective region 200, 202, 204, and 206. To generate the display image data 46, the first resampler 44A may apply a first resolution compensation factor to the portion of the image data corresponding to the first region 200, the second resampler 44B may apply a second resolution compensation factor to the portion of the image data corresponding to the second region 202, the third resampler 44C may apply a third resolution compensation factor to the portion of the image data corresponding to the third region 204, and/or the fourth resampler 44D may apply a fourth resolution compensation factor to the portion of the image data corresponding to the first boundary region 206. The display panel 40 may receive and display the display image data 46 to display a frame of image content without perceivable image artifacts.

In certain instances, the first resampler 44A and/or the second resampler 44B may receive and process the input image data 42 for the first boundary region 206. For example, the first resampler 44A may adjust the input image data 42 corresponding to both the first region 200 and the first boundary region 206. In another example, the second resampler 44B may adjust the input image data 42 corresponding to the second region 202 and the first boundary region 206. Still in another example, the first resampler 44A may adjust the input image data 42 corresponding to a portion of the first boundary region 206 and the second resampler 44B may adjust the input image data 42 corresponding to a remaining portion of the first boundary region 206. The first resampler 44A may adjust the input image data 42 corresponding to the portion of the first boundary region 206 adjacent to the first region 200 and the second resampler 44B may adjust the input image data 42 corresponding to the portion of the first boundary region 206 adjacent to the second region 202.

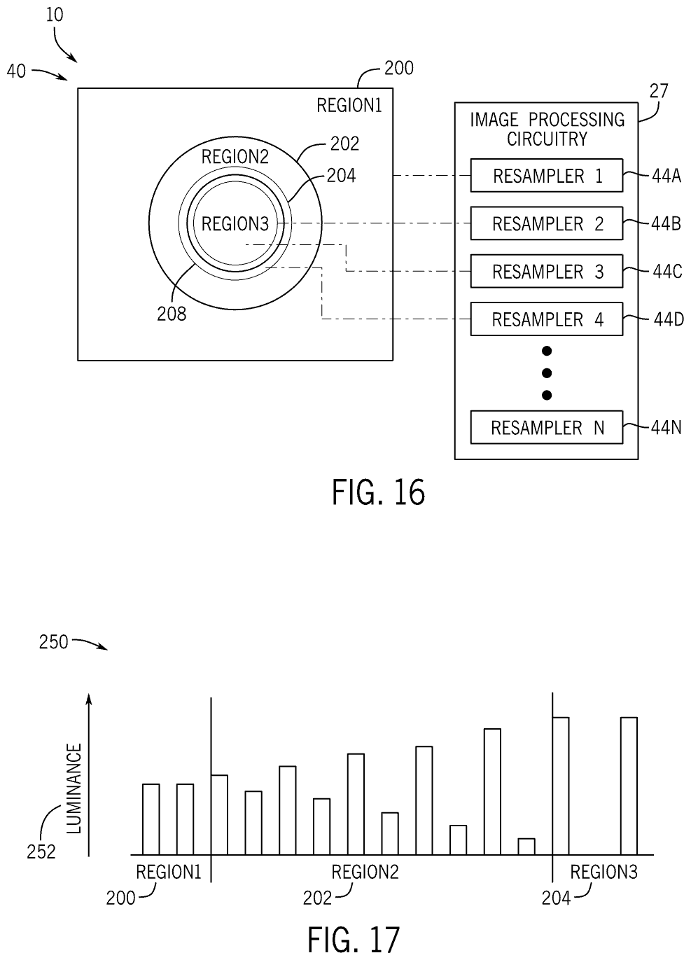

FIG. 16 is an example schematic diagram of the electronic device 10 with three regions 200, 202, and 204 having different resolutions and displaying the display image data 46 to form a frame of image content. For example, the first region 200 may include high pixel resolution, the second region 202 may include a middle pixel resolution, and the third region 204 may include a low pixel resolution. Between the second region 202 and the third region 204, the electronic device 10 may include a second boundary region 208. The second boundary region 208 may include a pixel resolution between the middle pixel resolution and the low pixel resolution. As such, the second boundary region 208 may facilitate reducing the perceivability of changes between the second region 202 and the third region 204, which may facilitate decreasing any perceivable image artifacts that may result from different pixel resolutions and/or different pixel layouts.

Each region 200, 202, 204 and/or each boundary region 206, 208 may be provided with display image data 46 that may be processed by a respective resampler 44. For example, a first resampler 44A may adjust the input image data 42 corresponding to the first region 200 based on a first resolution compensation factor, a second resampler 44B may adjust the input image data 42 corresponding to the second region 202 based on a second resolution compensation factor, a third resampler 44C may adjust the input image data 42 corresponding to the third region 204 based on a third resolution compensation factor, and/or a fourth resampler 44D may adjust the input image data 42 corresponding to the second boundary region 208 based on a fourth resolution compensation factor. Each resampler 44 may apply a respective resolution compensation factor to adjust the input image data 42 based on the pixel layout of the respective region. For example, input image data 42 corresponding to a region implementing a lower pixel resolution may be adjusted with a higher resolution compensation factor in comparison to input image data 42 corresponding to a region implementing a higher pixel resolution. The input image data 42 corresponding to the boundary region 208 may, for example, be adjusted with a third resolution compensation factor between the first resolution compensation factor and the second resolution factor.

The example pixel layouts of FIGS. 12-16 are illustrative non-limiting examples. It may be understood that the pixel layouts may include different variations, such as a shape and/or size of each region may vary, a number pixel layouts may vary, and the number of resamplers 44 may vary. For example, a shape of the regions 200, 202, 204 may be square, trapezoidal, and/or any suitable shape instead of circular. In another example, a resampler 44 may be dedicated to each region and/or boundary.

FIG. 17 is a graph 250 illustrating target luminance levels 252 for display pixels 48 positioned in different regions 200, 202, 204 of the electronic device 10. As discussed herein, the input image data 42 may be adjusted to generate the display image data 46 that may include target luminance levels for each display pixel 48 for displaying a frame of image content.

By way of example, the third region 204 may implement half as many display pixels 48 as the first region 200 and the second region 202 may be a boundary region between the first region 200 and the second region 202. As illustrated by the graph 250, the target luminance for display pixels 48 in the first region 200 may be 0.5, and the target luminance for display pixels 48 in the third region 204 may be 1.0. That is, the display pixels 48 in the third region 204 may be driven to emit twice as much light in comparison to the display pixels 48 within the first region 200 to reach similar perceivable luminance levels. However, it may be understood that the first region 200, the second region 202, and the third region 204 may be any suitable pixel resolution. For example, the first region 200 may include a target luminance of 0.25, the second region 202 may include a target luminance of 0.75, and the third region 204 may include a target luminance of 1. That is, the second region 202 may include 3× pixel resolution in comparison to the first region 200.

To facilitate the transition from the first region 200 to the third region 204, the resolution compensation factor may be applied to the input image data 42 corresponding with every other line of display pixels 48 may gradually increase and the resolution compensation factor corresponding with the remaining lines of display pixels 48 may gradually decrease. For example, the resolution compensation factors may gradually decrease over the course of a first (e.g., even numbered) set of lines and gradually increase over the course of a second (e.g., odd numbered) set of lines.

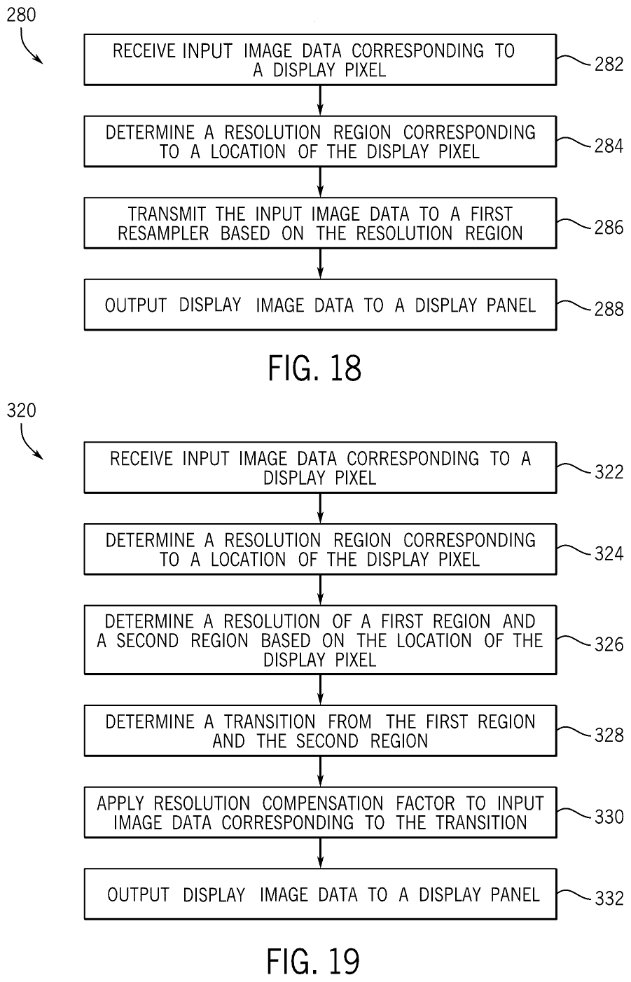

FIG. 18 is a flowchart of an example method 280 for receiving and processing the input image data for the display panel. While the process of FIG. 18 is described using process blocks in a specific sequence, it should be understood that the present disclosure contemplates that the described process blocks may be performed in different sequences than the sequence illustrated, and certain described process blocks may be skipped or not performed altogether.

At block 282, the image processing circuitry may receive source image data corresponding to a display pixel. For example, the image processing circuitry may receive the input image data from the image source.

At block 284, the image processing circuitry may determine a resolution region corresponding to the location of the display pixels. For example, the image processing circuitry may determine if the location of the display pixel in the display panel corresponds to the first region, the second region, and/or the third region. Additionally or alternatively the image processing circuitry may determine if the location of the display pixel within the display panel corresponds to the first boundary region and/or the second boundary region. In certain instances, the image processing circuitry may receive an indication of pixel layout of the display panel that may indicate different pixel layouts corresponding to different regions of the display panel. The image processing circuitry may determine the resolution region corresponding to the display pixel based at least in part on the indication.

At block 286, the image processing circuitry may transmit the input image data to a first resampler based on the resolution region. For example, the image processing circuitry may determine the location of the display pixel corresponds to the first region and transmit the input image data to the first resampler for processing. The first resampler may process (e.g., adjust) the input image data to generate the output image data, which may reduce or eliminate perceivable variations resulting from differing pixel resolutions. The first resampler may convert the input image data from a gamma space to a linear space prior to applying the resolution compensation factor. The first resampler may adjust the converted input image data by applying one or more filter parameters to the converted input image data, apply one or more gain values to match luminance values across the corresponding region, and the like. The first resampler may convert the adjusted input image data from the linear space to the gamma space to generate the output image data. As discussed herein, each resolution region of the display panel may be associated with a respective resampler that processes the input image data based on the pixel layout of the respective resolution region.

At block 288, the image processing circuitry may output display image data to the display pixel. For example, the resampler may adjust the input image data based on the pixel layout of the resolution region. The resampler may output the display image data to the display panel for driving the display pixel.

FIG. 19 is a flowchart of an example method 320 or receiving and processing the input image data for the display panel. While the process of FIG. 19 is described using process blocks in a specific sequence, it should be understood that the present disclosure contemplates that the described process blocks may be performed in different sequences than the sequence illustrated, and certain described process blocks may be skipped or not performed altogether.

At block 322, the image processing circuitry may receive input image data corresponding to a display pixel, similar to block 282 described with respect to FIG. 18. At block 324, the image processing circuitry may determine a resolution region corresponding to the display pixel, similar to block 284 described with respect to FIG. 18.

At block 326, the image processing circuitry may determine a resolution of a first region and a second region based on the location of the display pixel. For example, the image processing circuitry may determine the location of the display pixel to be between the first region and the second region. The image processing circuitry may determine a pixel layout of the first region and a pixel layout of the second region. Additionally or alternatively, the image processing circuitry may determine the location of the display pixel to be between the second region and the third region. As such, the image processing circuitry may determine the pixel layout of the second region and/or the third region. Still in another example, the image processing circuitry may determine the location of the display pixel to be between the first region and the third region.

At block 328, the image processing circuitry may determine a transition from the first region to the second region. The image processing circuitry may determine a pixel layout of the boundary region based on the pixel layout of the first region and the pixel layout of the second region. Additionally or alternatively, the image processing circuitry may determine a pixel layout of a boundary region based on the second region and/or the third region, the first region and the third region, or any combination thereof.

At block 330, the image processing circuitry may apply a resolution compensation factor to the input image data corresponding to the transition. For example, the first resampler may apply a gain value to the source image data, apply a filter to the source image data, convert the source image data from a gamma region to a linear region, convert a processed image data from the linear region to the gamma region, and so on. The resolution compensation factor may include the gain value and/or a filter value. For example, the resolution factor may be applied to input image data corresponding to the second region and/or the third region to drive the corresponding display pixels to emit light at a greater target luminance in comparison to the first region. In this way, the display panel 40 may be perceived to emit light without image artifacts.

At block 332, the image processing circuitry may output display image data to the display panel, similar to block 288 described with respect to FIG. 18.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. An electronic device comprising:
a display panel comprising a first region having a first pixel layout and a second region having a second pixel layout;
a sensor disposed behind the first region; and
image processing circuitry communicatively coupled to the display panel, wherein the image processing circuitry is configured to process image data associated with the first region of the display panel using a first pixel layout resampler and process image data associated with the second region of the display panel using a second pixel layout resampler.

2. The electronic device of claim 1, wherein the image processing circuitry is configured to:
receive the image data associated with the first region and the second region;
determine a spatial position on the display panel of the image data; and
process the image data based on the spatial position using the first pixel layout resampler or the second pixel layout resampler based on the spatial position.

3. The electronic device of claim 1, wherein:
the display panel comprises a third region implemented with a third pixel layout; and
the image processing circuitry is configured to process image data associated with the third region of the display panel using a third pixel layout resampler.

4. The electronic device of claim 3, wherein:
the display panel comprises a first boundary region between the first region and the second region and a second boundary region between the second region and the third region; and
the image processing circuitry is configured to process image data associated with the first boundary region and the second boundary region.

5. The electronic device of claim 4, wherein the image processing circuitry is configured to process the image data associated with the first boundary region using a fourth pixel layout resampler, and the image data associated with the second boundary region using a fifth pixel layout resampler.

6. The electronic device of claim 1, wherein:
the display panel comprises a boundary region comprising an area of pixels in the first region and an area of pixels in the second region adjacent to the area of pixels in the first region; and
the image processing circuitry is configured to process image data associated with the boundary region differently from pixels of the first region not in the boundary region and differently from pixels of the second region not in the boundary region.

7. The electronic device of claim 6, wherein the image processing circuitry is configured to process image data associated with the boundary region using a different set of pixel gains than applied to pixels of the first region not in the boundary region or to pixels of the second region not in the boundary region.

8. The electronic device of claim 1, wherein the first region comprises a lower resolution than the second region, wherein the image processing circuitry is configured to apply a higher gain to the image data associated with the first region than to the image data associated with the second region of the display panel.

9. The electronic device of claim 1, wherein the first region comprises a lower resolution than the second region.

10. The electronic device of claim 1, wherein:
the display panel comprises a third region having a third pixel layout, wherein the third region comprises a resolution greater than a resolution of the first region and less than a resolution of the second region.

11. A system comprising:
an electronic display comprising a plurality of regions having different respective pixel layouts; and
image processing circuitry communicatively coupled to the electronic display, wherein the image processing circuitry is configured to process image data associated with different regions of the plurality of regions.

12. The system of claim 11, wherein the image processing circuitry is configured to:
apply a first resolution compensation factor based on a first pixel layout of a first region of the plurality of regions; and
apply a second resolution compensation factor based on a second pixel layout of a second region of the plurality of regions.

13. The system of claim 12, wherein the first pixel layout implements a higher pixel resolution than the second pixel layout.

14. The system of claim 12, wherein the second resolution compensation factor is greater than the first resolution compensation factor.

15. The system of claim 11, wherein the electronic display comprises a boundary region between at least two of the plurality of regions, wherein the image processing circuitry is configured to process image data associated with the boundary region using a different layout resampler than those used for the different regions of the plurality of regions.

16. Image processing circuitry configured to perform one or more operations comprising:
process image data associated with a first region of an electronic display having a first pixel layout using a first pixel layout resampler and a first resolution compensation factor; and
process image data associated with a second region of the electronic display having a second pixel layout using a second pixel layout resampler and a second resolution compensation factor.

17. The image processing circuitry of claim 16, wherein the image processing circuitry is configured to:
determine the first resolution compensation factor based on a first gain map corresponding to the first pixel layout; and
determine the second resolution compensation factor based on a second gain map corresponding to the second pixel layout, wherein the second resolution compensation factor is greater than the first resolution compensation factor.

18. The image processing circuitry of claim 16, wherein the image processing circuitry is configured to:
determine a third resolution compensation factor based on a third gain map and a third pixel layout of a third region of the electronic display, wherein the third pixel layout comprises a pixel resolution greater than the second pixel layout and less than the first pixel layout, and wherein the third resolution compensation factor is greater than the first resolution compensation factor and less than the second resolution compensation factor; and
process image data associated with the third region using a third pixel layout resampler and the third resolution compensation factor.

19. The image processing circuitry of claim 16, wherein the image processing circuitry is configured to:
process image data associated with a boundary between the first region and the second region using a third pixel layout resampler and a third resolution compensation factor.

20. Image processing circuitry comprising:
first pixel layout resampling circuitry configured to resample pixel data associated with a first pixel layout of an electronic display; and
second pixel layout resampling circuitry configured to resample pixel data associated with a second pixel layout of the electronic display, wherein the second pixel layout is different from the first pixel layout.

21. The image processing circuitry of claim 20, wherein the second pixel layout has a higher pixel density than the first pixel layout.

22. The image processing circuitry of claim 20, wherein the second pixel layout has a different relative positioning of different color subpixels than the first pixel layout.
